(19) United States
(12) Patent Application Publication
(10) Pub. No.: US 2003/0005191 A1
(43) Pub. Date: Jan. 2, 2003

(54) Integrated circuit method and apparatus

(76) Inventors: Mark D. Montierth, Meridian, ID (US); Richard D. Taylor, Eagle, ID (US)

Correspondence Address: AGILENT TECHNOLOGIES, Legal Department, 51U-PD, Intellectual Property Administration, P.O. Box 58043, Santa Clara, CA, 95052-8043, US

(21) Appl. No.: 09/733,510

(22) Filed: Dec. 8, 2000

(51) Int. Cl. G06F 13/38; G06F 13/40

(52) U.S. Cl. 710/104; 710/313

(57) ABSTRACT

An integrated circuit (IC) apparatus and method utilizes a first IC (111) having a plurality of voltage-tolerant interconnects (115) and a bus interface (113) that is arranged and constructed to receive data that controls the plurality of voltage-tolerant interconnects (115) and a second IC (111) that has a plurality of logic circuits (103 and 105) arranged and constructed to provide the data via a bus (109) to the first IC (111), and the second IC (111) has less voltage tolerance than the first IC (111). A third IC device having less voltage tolerance than the first IC (111) device may replace the second IC (111) and provide at least one different feature than is provided by the combination of the first IC (111) and the second IC (101).

### FIELD OF THE INVENTION

This invention relates to electronic devices, including but not limited to integrated circuits and applications thereof.

### BACKGROUND OF THE INVENTION

Integrated circuits and uses thereof are well known. Most electronic devices are comprised of integrated circuits (ICs) comprised of processing or logic circuitry, memory with stored programming instructions, and interconnections to various input and output devices, also known as peripheral devices, to be controlled by the ICs, such as computers, printers, communication devices including telephone lines, and other hardware. As electronic devices have evolved, a greater number of input and output devices need to be controlled by the ICs, resulting in an ever-increasing number of pins required on the ICs to connect with all the peripherals.

As ICs have developed throughout the years, the technology used to develop them has been required to create more and more logic in smaller and smaller spaces. As ICs have gotten smaller and pins have increased, so has the cost to manufacture them as well as the time to produce mask sets from which to fabricate them.

Although ICs have quickly developed to devices comprised of 1.2 V and 0.13 micron technology, older technology ICs, such as those utilizing 5.0 V 0.35 micron technology, still remain in use. Such devices include those used to interconnect hardware, such as printer and computer drivers. When newer ICs, having lower voltage tolerance and requirements, interface with older ICs, having higher voltage tolerance and requirements, the newer ICs may be unable to drive the older ICs or the older ICs may blow out the interconnections on the newer ICs. In order to prevent such problems from occurring, newer ICs are fabricated with extra layers or masks that are tolerant to the higher voltages, typically by adding large voltage tolerant pads for each pin. With the large number of pins required on these devices, fabricating these layers is very expensive and consumes a lot of space, and for every cycle of fabrication required, very time consuming. Furthermore, whenever a new product or change in peripheral device occurs, a new IC must be fabricated.

Accordingly, there is a need for an IC configuration that is less expensive and time consuming yet provides adequate logic and processing for a large number of peripheral devices.

### BRIEF DESCRIPTION OF THE DRAWINGS

FIG. 1 is a diagram showing an apparatus comprising a pair of integrated circuits in accordance with the invention.

FIG. 2 is a flowchart showing a method of devising integrated circuits in accordance with the invention.

### DESCRIPTION OF A PREFERRED EMBODIMENT

The following describes an apparatus for and method of utilizing integrated circuits. A first IC comprises voltage-tolerant interconnects and receives control data for the voltage-tolerant interconnects via a bus. For purposes of claim construction, the term ‘bus’ is considered to be an electrically conductive pathway over which electrical signals are, or can be, transferred from one point of a circuit to another. ‘Bus’ examples include, but are not limited to wires, resistive and non-resistive conductive circuit lines or traces, gates and the like. A second IC comprises logic circuits that provide the control data via the bus to the first IC. The second IC has less voltage tolerance than the first IC.

The present invention comprises a bus and a first integrated circuit having a plurality of voltage-tolerant interconnects and a bus interface that is arranged and constructed to receive data that controls the plurality of voltage-tolerant interconnects. A second integrated circuit has a plurality of logic circuits arranged and constructed to provide the data via the bus to the first integrated circuit, and the second integrated circuit has less voltage tolerance than the first integrated circuit. A third integrated circuit device having less voltage tolerance than the first integrated circuit device may replace the second integrated circuit and provide at least one different feature than is provided by the combination of the first integrated circuit and the second integrated circuit.

A method of the present invention comprises the steps of devising a first integrated circuit having a plurality of voltage-tolerant interconnects and a bus interface that receives, via a bus, data that controls the plurality of voltage-tolerant interconnects, and devising a second integrated circuit having a plurality of logic circuits that provide the data via the bus to the first integrated circuit, wherein the second integrated circuit has less voltage tolerance than the first integrated circuit. The method may further comprise the steps of devising a third integrated circuit having less voltage tolerance than the first integrated circuit and replacing the second integrated circuit with the third integrated circuit to provide at least one different feature than provided by the combination of the first integrated circuit and the second integrated circuit.

In the preferred embodiment, the plurality of voltage-tolerant interconnects is capable of handling at least 5 volts ±20% and the second integrated circuit is capable of handling up to 1.2 volts ±20%. The bus may be a high-speed serial bus, and preferably comprises three or fewer interconnections between the first integrated circuit and the second integrated circuit. For purposes of claim construction, a ‘high-speed bus’ is considered to be a bus having a transfer-rate, latency, and throughput sufficient to handle all I/O's at 100% of their transfer speed. Examples of a ‘high-speed bus’ include, but are not limited to USB 2.0 (480 MBit/s), IEEE 1394 (400 MBit/s), etc and equivalents thereof. The second integrated circuit may comprise over 50 interconnects. The first integrated circuit, the second integrated circuit, and the bus may be disposed within a printer.

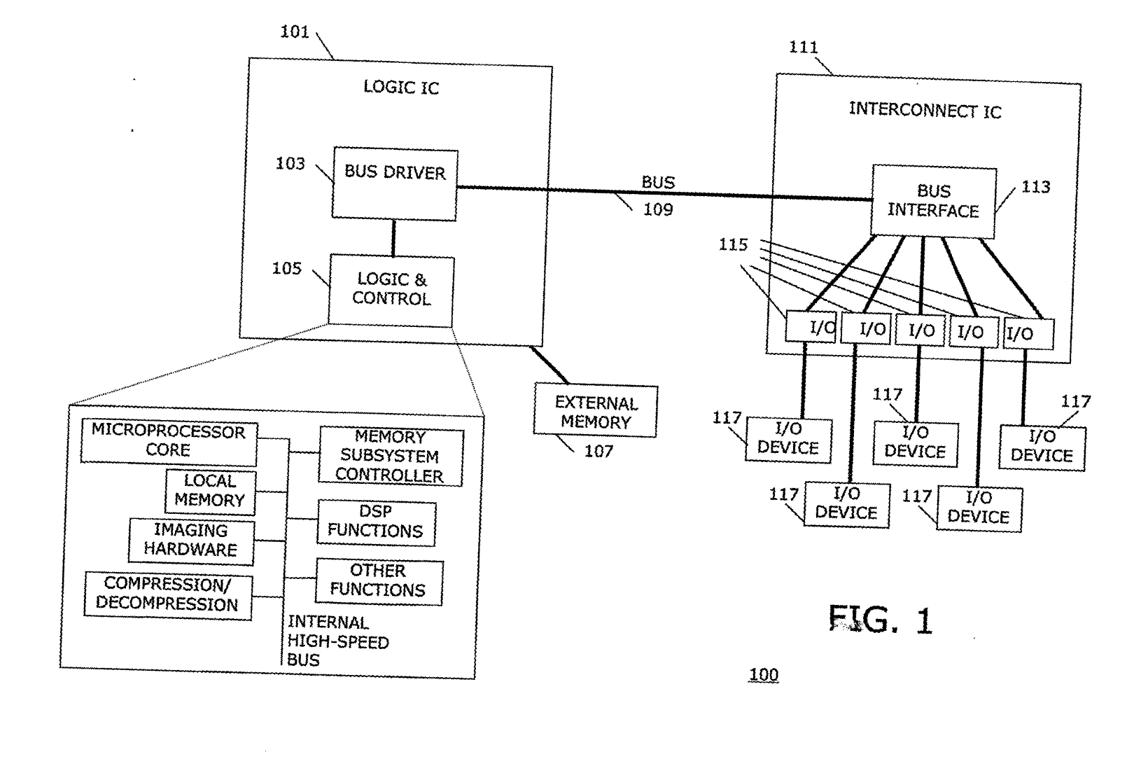

The diagram of FIG. 1 shows an apparatus 100, such as a printer, computer, telecommunications device, and so forth, that comprises a pair of integrated circuits in accordance with the invention. A logic IC 101 comprises a bus driver 103 and logic and control circuitry 105. The logic and control circuitry 105 contains circuitry that provides logic and control circuitry specific to providing the functions characteristic of the apparatus, such as a microprocessor core, local memory, imaging hardware, compression/decompression circuitry, a memory subsystem controller, DSP (Digital Signal Processing) functions, and other functions as appropriate. The logic IC 101 accesses external memory 109 and any other circuitry as needed.

The bus driver 103 places data and other control information on a bus 109. In the preferred embodiment, the bus 109 is a high speed serial bus, preferably three lines or less, such as a 480 Mbps Universal Serial Bus 2 (USB2) protocol bus that has two bi-directional low-voltage lines that provide a high speed data interface between the logic IC 101 and an interconnect IC 111. Alternatively, a 10 Gbps internet bus could be used. A bus with more than three lines, such as an 8-line or 16-line parallel bus could be used, but such an arrangement would increase the complexity and cost of the logic IC 101 and interconnect IC 111. Because the latest IC technology is capable of providing many gates in a small area, placing the majority of the logic for the apparatus 100 in the logic IC 101, in the logic and control circuitry 105 in the preferred embodiment, is advantageous.

Because the logic IC 101 need only drive the bus 109 and external memory 107, the logic IC 101 need only have low voltage tolerance, such as up to 1.2 volts ±20%. The logic IC 101 requires very few pins to drive the bus 109, i.e., as few as 2, and has low voltage tolerance, thus it is an ideal candidate for the latest high-tech IC fabrication, such as Application Specific Integrated Circuits (ASICs) in 0.13 micron technology, 0.10 micron technology, and beyond, without the need for extra time-consuming and expensive fabrication steps that would needed for higher voltage tolerance and higher pin counts. The logic IC 101 may be fabricated in standard (non-custom) processes that are relatively inexpensive and meet the best price point for the market window of the final product.

An interconnect IC 111 comprises a bus interface 113 that receives data and control information from the logic IC 101 via the bus 109 and processes it appropriately to drive the I/O (input/output) drivers 115 that control the I/O devices 117. The 10 drivers 115 include, for example, LIO (Low pincount Input/Output), RS232 serial, I²C, Universal Serial Bus, IEEE 1284, GPIOs, and other IO driver standards and protocols as known in the art.

The I/O devices 117 may include keypads or keyboards, printer heads, motor drivers, host computers, non-volatile storage, expansion cards, serial ports, wireless cards, LCD displays, motor control chips for paper handling accessories, and various status indicators in the case where the apparatus 100 is a printer. The I/O devices 117 may include a keyboard, mouse, monitor, modem, graphics card, host computers, non-volatile storage, expansion cards, serial ports, and wireless cards in the case where the apparatus 100 is a computer. Other I/O devices 117 include telephone lines, in the case of a fax machine or telephone system; speakers and microphones, for cellular phones, landline telephones, and radios, and so forth.

Because many of I/O devices are typically 5 V to 12 V devices, the interconnect IC 111 must be voltage tolerant such that the interconnect pads in the I/Os 115 are capable of safely driving (sourcing) or receiving (sinking) signals of voltages 12 V ±20% or higher as appropriate, such as 40 V ±20% for wireline telephony. Thus, the I/Os 115 contain voltage-tolerant interconnects sufficient and appropriate to drive the I/O devices 117. Due to the typically large number of I/O devices 117 and the number of interconnects that are needed between the interconnect IC III and each I/O device 117, the interconnect IC 111 has a high pin count, typically 50 or more. Because a lot of logic is not required to provide the functions of the interconnect IC 111, and because of the requirement for higher voltage tolerance than the logic IC 101 requires, a more robust technology, such as 0.35 to 0.5 micron technology, is ideal for fabricating the interconnect IC 111 because it is less expensive than 0.13 or 0.10 micron technology to provide the same characteristics, features, and functionality, particularly given the high pin count of the interconnect IC 111. Specialty analog functions, such as phase-locked loops, are easier to implement in older technologies, and thus may be implemented in the interconnect IC 111, thereby reducing external part count in the apparatus 100.

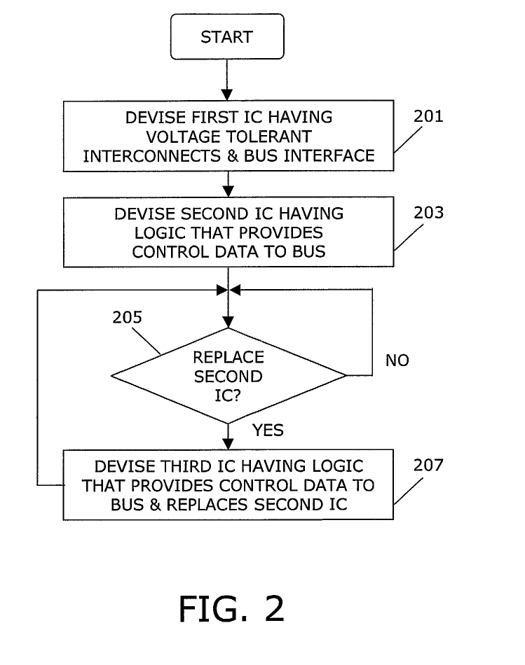

A flowchart showing a method of devising ICs is shown in FIG. 2. At step 201, a first IC, such as the interconnect IC 111 described above, is devised with voltage tolerant interconnects and a bus interface. At step 203, a second IC, such as the logic IC 101 described above, is devised with logic that provides control data to the bus 109. At step 205, it is determined whether it is desirable to replace the second IC. Replacement of the second IC may occur for various reasons, such as new (future) product development, product updates, and adding product enhancements. The interconnect IC 111 couples to peripheral devices 117 that tend not to change very often (i.e., over a few years) and/or tend not to change their interfaces very often. The features and functions, as set forth in the logic and control circuitry 105, as provided by an apparatus 100, such as printers or computers, tend to change very often, sometimes every three to six months. When it is desirable to replace the second IC, a third IC is devised with logic that provides control data to the bus 109 and replaces the second IC, while continuing to utilize the first IC as is. The third IC is basically the same in construction as the logic IC 101, i.e., much of the logic, schematics, and so forth may be reused, although new feature(s) and/or function(s) may be added. The third IC may be designed using the same technology as the first IC, or may be designed in the best and/or more appropriate current process technology. Alternatively, the third IC may be a complete redesign, without reuse of the first IC's design. Thus, the interconnect IC 111 may be utilized with a third IC that is a new logic IC 101 that is upgraded, updated, and/or adds features and functions not present in its predecessor logic IC 111.

The present invention maximizes reuse of and minimizes total cost of IC architectures, particularly when it is desirable to provide control for a large number of higher-voltage interconnects. The advantages of highly advanced compact circuit design are utilized in one IC to handle the majority of logic and control requirements, whereas less complex but less expensive technology is utilized to provide higher voltage tolerance to a large number of interconnects on another IC. The high interconnect IC can be used with a number of different logic ICs both simultaneously and as products advance. The IC architecture described herein may be utilized in a wide variety of logic drive devices that utilize many I/Os. Because both ICs 101 and 111 have fewer pins, the ICs 101 and 111 may be embodied in smaller, cheaper packages, such as an 80 pqfp (plastic quad flat pack). The present invention provides for design reuse across generations of one product as well as product families. Lower system cost, less design resource requirement, and simpler design verification result from use of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus comprising:
a bus;
a first integrated circuit having a plurality of voltage-tolerant interconnects and a bus interface that is arranged and constructed to receive data that controls the plurality of voltage-tolerant interconnects;
a second integrated circuit having a plurality of logic circuits arranged and constructed to provide the data via the bus to the first integrated circuit, wherein the second integrated circuit has less voltage tolerance than the first integrated circuit.

2. The apparatus of claim 1, wherein the plurality of voltage-tolerant interconnects is capable of handling at least 5 volts ±20% and the second integrated circuit is capable of handling up to 1.2 volts ±20%.

3. The apparatus of claim 1, wherein the bus is a high-speed bus.

4. The apparatus of claim 1, wherein the bus comprises three or fewer interconnections between the first integrated circuit and the second integrated circuit.

5. The apparatus of claim 1, wherein the second integrated circuit comprises over 50 interconnects.

6. The apparatus of claim 1, wherein the first integrated circuit, the second integrated circuit, and the bus are disposed within a printer.

7. The apparatus of claim 1, further comprising a third integrated circuit device having less voltage tolerance than the first integrated circuit device, wherein the third integrated circuit replaces the second integrated circuit and provides at least one different feature than is provided by the combination of the first integrated circuit and the second integrated circuit.

8. A method comprising the steps of:
devising a first integrated circuit having a plurality of voltage-tolerant interconnects and a bus interface that receives, via a bus, data that controls the plurality of voltage-tolerant interconnects;
devising a second integrated circuit having a plurality of logic circuits that provide the data via the bus to the first integrated circuit, wherein the second integrated circuit has less voltage tolerance than the first integrated circuit.

9. The method of claim 8, further comprising the steps of:
devising a third integrated circuit having less voltage tolerance than the first integrated circuit;
replacing the second integrated circuit with the third integrated circuit to provide at least one different feature than provided by the combination of the first integrated circuit and the second integrated circuit.

10. The method of claim 8, wherein the plurality of voltage-tolerant interconnects is capable of handling at least 5 volts ±20% and the second integrated circuit is capable of handling up to 1.2 volts ±20%.

11. The method of claim 8, wherein the bus is a high-speed bus.

12. The method of claim 8, wherein the bus comprises three or fewer interconnections between the first integrated circuit and the second integrated circuit.

13. The method of claim 8, wherein the second integrated circuit comprises over 50 interconnects.

14. The method of claim 8, wherein the first integrated circuit, the second integrated circuit, and the bus are disposed within a printer.
